(19) United States
(12) Patent Application Publication
(10) Pub. No.: US 2008/0032593 A1
(43) Pub. Date: Feb. 7, 2008

(54) EYE MODULE AND FACIAL EXPRESSION MODULE AND DISPLAY METHOD THEREOF

(75) Inventors: Chung-Cheng Chou, Taoyuan County (TW); Wai William Wang, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taoyuan Shien (TW)

(21) Appl. No.: 11/830,895

(22) Filed: Jul. 31, 2007

(30) Foreign Application Priority Data
Aug. 2, 2006 (TW) 95128392

(51) Int. Cl. A63H 3/40; G02B 3/14

(52) U.S. Cl. 446/343; 359/666

(57) ABSTRACT

An eye module and a facial expression module and a display method thereof are provided. The eye module at least includes a transparent casing and an eye element. The eye element is disposed inside the transparent casing for representing a pupil of the eye module. The eye element includes a conductive liquid, a first electrode and a second electrode. The conductive liquid is for representing the pupil. The first electrode is coupled with the conductive liquid. The second electrode is electrically isolated from the first electrode and the conductive liquid. The first electrode and the second electrode generate a first voltage difference in the conductive liquid to cause the deformation, expansion or displacement of the conductive liquid. As a result, the pupil is changed accordingly.

This application claims the benefit of Taiwan application Serial No. 095128392, filed Aug. 2, 2006, the subject matter of which is incorporated herein by reference.

### BACKGROUND OF THE INVENTION

1. Field of the Invention

The invention relates in general to an eye module, a facial expression module and a display method thereof and more particularly to an eye module, a facial expression module and a display method thereof using a conductive liquid representing a pupil or expression.

2. Description of the Related Art

As the technology progresses, smart devices are widely applied to all kinds of consumer electronic products or computer peripherals. The smart device, such as a robot or a robot pet, has artificial intelligence. The robot is beneficial to the automatic production and able to handle things for people, and the robot pet brings joy to people's lives. Several kinds of artificial intelligence technology are applied to the smart devices to represent the eyes and facial expression, which are important ways for the smart devices to express emotion and interaction.

A motor and several gears are disposed on the face in a conventional eye module and the facial expression module. The motor is controlled to drive the rotation of the gears for generating the expression of the eye and the face. Several light modules are disposed on the face in another conventional eye module and facial expression module. The light modules are controlled to represent different expressions of the eye and the face. However, the conventional eye module and facial expression module have following disadvantages.

First, the mechanism design is complicated, and the manufacture of the conventional eye module and the facial expression module is very difficult. The motor and the gears are complex. Therefore, the requirement for high accuracy and low tolerance is necessary, which increases difficulty in the manufacture. It is hard to design, and the manufacturing cost is considerably expensive.

Second, the noise is loud. The motor has to contact the gears in order to drive the gears. Therefore, when the motor and the gears operate, the noise is loud.

Third, the mechanisms are worn out easily. After the gears are used for a long time, the gears are worn out for a certain level or even not able to be used anymore. As a result, the service life of the smart device is reduced greatly.

Fourth, the size is huge. Both the gears and the light module have certain volume, so the smart device can not be thin, compact and lightweight.

Fifth, limited to the structure of the gears and the light modules, the expression of the eyes and face is dull.

### SUMMARY OF THE INVENTION

The invention is directed to an eye module and a facial expression module and a display method thereof. A voltage difference is generated in a conductive liquid to cause the deformation, expansion or displacement of the conductive liquid. As a result, the pupil and the facial expression are changed. The eye module and the facial expression module and the display method thereof have advantages including simple structure, low noise, long service life (not worn out easily), compact size, vivid expression, several-stage change and mass production easily,

According to the present invention, an eye module including a transparent casing and an eye element is provided. The eye element is disposed inside the transparent casing for representing a pupil of the eye module. The eye module includes a conductive liquid, a first electrode and a second electrode. The conductive liquid is for representing the pupil. The first electrode is coupled with the conductive liquid. The second electrode is electrically isolated from the first electrode and the conductive liquid. The first electrode and the second electrode generate a first voltage difference in the conductive liquid to cause the deformation, expansion or displacement of the conductive liquid for changing the pupil.

According to the present invention, a facial expression module including a transparent casing and an expression element is provided. The expression element is disposed inside the transparent casing for representing the facial expression. The facial expression element includes a conductive liquid, a first electrode and a second electrode. The conductive liquid is for representing expression. The first electrode is coupled with the conductive liquid. The second electrode is electrically isolated from the first electrode and the conductive liquid. The first electrode and the second electrode generate a first voltage difference in the conductive liquid to cause the deformation, expansion or displacement of the conductive liquid. As a result, the expression is changed.

According to the present invention, a display method of an eye module is provided. The eye module includes a transparent casing and an eye element. The eye element is disposed inside the transparent casing and includes a conductive liquid for representing a pupil of the eye module. The display method includes following steps. First, a voltage difference is generated in the conductive liquid to cause the deformation, expansion or displacement of the conductive liquid. As a result, the pupil is changed.

According to the present invention, a display method of the facial expression module is provided. The facial expression module includes a transparent casing and an expression element. The facial element is disposed inside the transparent casing and includes a conductive liquid for representing expression. The display method includes following steps. First, a voltage difference is generated in the conductive liquid to cause the deformation, expansion or displacement of the conductive liquid.

The invention will become apparent from the following detailed description of the preferred but non-limiting embodiments. The following description is made with reference to the accompanying drawings.

### BRIEF DESCRIPTION OF THE DRAWINGS

FIGS. 1A-1B illustrates an eye module according to a first embodiment of the present inventions;

FIG. 1C illustrates the eye module in FIG. 1B applied to a robot pet;

FIG. 2A illustrates the conductive liquid in FIG. 1B on an expanding state;

FIG. 2B illustrates the eyes of the robot pet in FIG. 1C on another state;

FIGS. 3A˜4B illustrate the eye module and the robot pet according to a second embodiment of the present invention;

FIG. 5 illustrates the arrangement of the second electrode and the third electrode according to a third embodiment of the present invention;

FIGS. 6A˜8C illustrate the eye module and the robot pet according to the third embodiment of the present invention;

FIG. 9 illustrates a second electrode, a third electrode . . . and a ninth electrode according to a fourth embodiment of the present invention;

FIGS. 10A˜12C illustrate the eye module and the robot pet according to a fourth embodiment of the present invention;

FIG. 13 illustrates the second electrode, the third electrode . . . and the sixth electrode according to a fifth embodiment of the present invention;

FIGS. 14A˜16C illustrate the eye module and the robot pet according to the fifth embodiment of the present invention;

FIGS. 17A˜18B illustrate a facial expression module according to a sixth embodiment of the present invention; and

FIGS. 19A˜20C illustrate the facial expression module according to a seventh embodiment of the present invention.

### DETAILED DESCRIPTION OF THE INVENTION

### First Embodiment

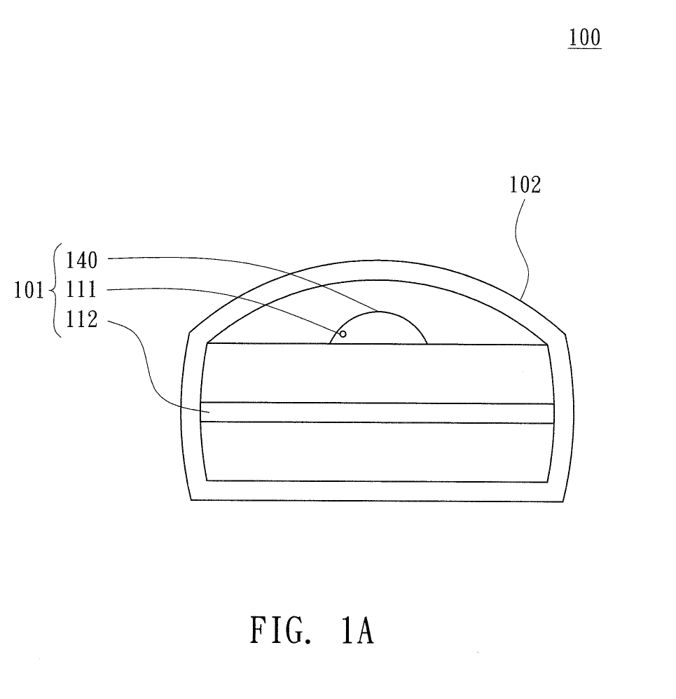

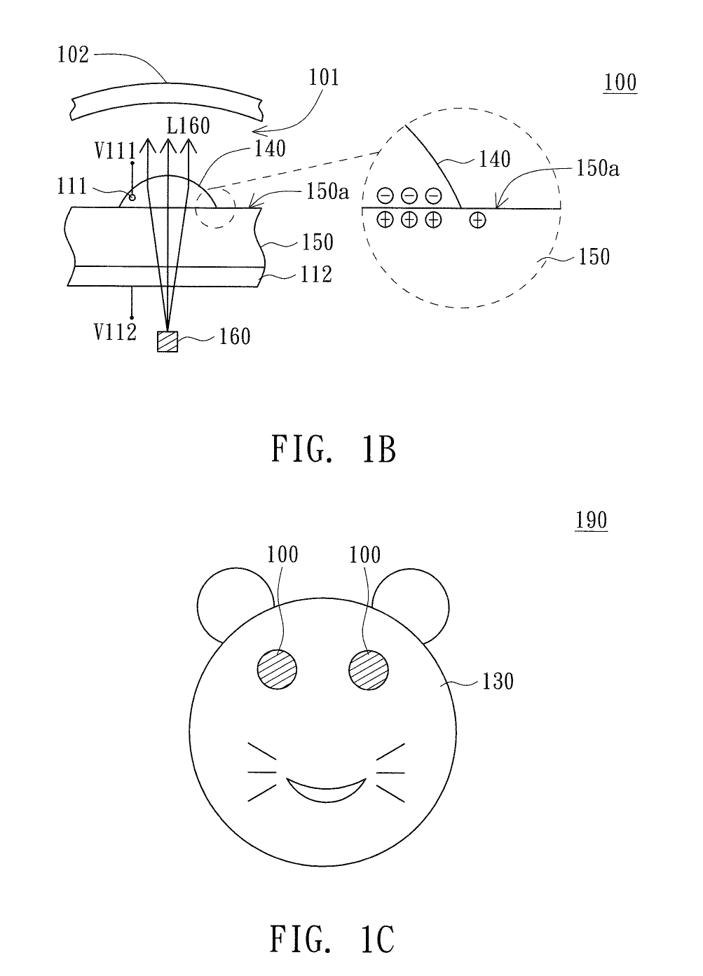

Please referring to both FIGS. 1A and 1B, an eye module 100 according to a firs embodiment of the present invention is illustrated in FIGS. 1A˜1B. As shown in FIG. 1A, the eye module 100 at least includes a transparent casing 102 and an eye element 101. The eye element 101 is disposed inside the transparent casing 102 for representing a pupil of the eye module 100.

As shown in FIG. 1B, the eye element 101 includes a conductive liquid 140, a first electrode 111 and a second electrode 112. The conductive liquid 140 is for representing the pupil. The first electrode 111 is coupled with the conductive liquid 140. The second electrode 112 is electrically isolated from the first electrode 111 and the conductive liquid 140. The first electrode 111 and the second electrode 112 generate a first voltage difference in the conductive liquid for causing the deformation, expansion or displacement of the conductive liquid 140. As a result, the pupil of the eye module is changed.

As stated above, the display of the eye module 100 at least includes following steps. First, the first voltage difference is generated in the conductive liquid 140 by the first electrode 111 and the second electrode 112. As shown in FIG. 1B, the first electrode 111 is corresponding to first electric potential V111, and the second electrode 112 is corresponding to second electric potential V112. The first voltage difference is the difference between the first electric potential V111 and the second electric potential V112.

The first electrode 111 directly contacts the conductive liquid 140. The eye element 101 further includes an insulation layer 150 disposed between the second electrode 112 and the conductive liquid 140. The conductive liquid 140 isolates the first electrode 111 and the second electrode 112 by the insulation layer 150.

The conductive liquid 140 is a solution containing electrolytes. For example, the conductive liquid 140 is salt solution or electrolyte. In the present embodiment, the conductive liquid 140 is made of a transparent material. The insulation layer 150 is made of glass or epoxy resin. In the present embodiment, the insulation layer 150 is made of glass. The first electrode 111 and the second electrode 112 are made of metal or indium tin oxide (ITO). ITO is transparent electrically conductive material. In the present embodiment, the first electrode 111 and the second electrode 112 are made of ITO.

The conductive liquid 140 isolates the first electrode 111 and the second electrode 112 through the insulation layer 150. Electro-wetting phenomenon is caused by the first voltage difference between the first electrode 111 and the second electrode 112. The electro-wetting phenomenon causes the deformation, expansion or displacement of the conductive liquid 140. The theorem of the electro-wetting phenomenon is described briefly as follow.

As shown in FIG. 1B, when the first electric potential V111 corresponding to the first electrode 111 is slightly less (or even equal to) the second electric potential V112 corresponding to the second electrode 112, first voltage difference (V112˜V111) is generated on the contact surface between the conductive liquid 140 and the insulation layer 150. The insulation layer 150 isolates the conductive liquid 140 and the second electrode 112. Therefore, after negative charges are applied to the conductive liquid 140 by the first electrode 111, the negative charges in the conductive liquid 140 gather on the contact surface 150a. Also, the positive charges in the insulation layer 150 gather on the contact surface 150a. In FIG. 1B, the first voltage difference (V112-V111) is considerably small (or even equal to zero). Only a few negative charges and positive charges gather on the contact surface 150a. Therefore, the contact surface 105a is hydrophobic. The conductive liquid 140 contracts on and protrudes from the contact surface 105a. The surface curvature of the conductive liquid 140 is larger.

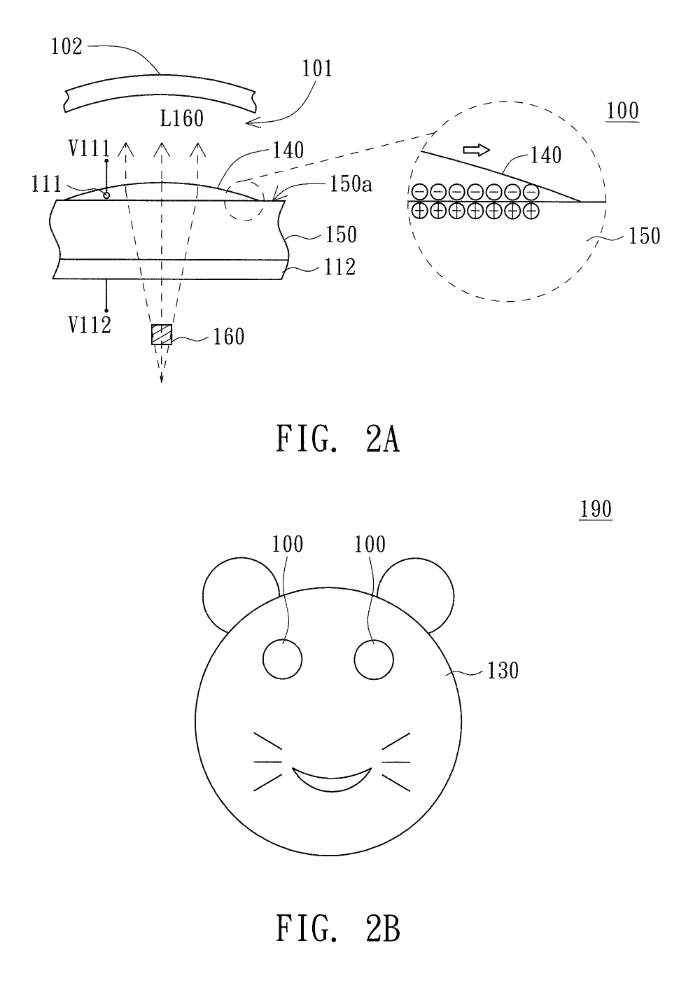

Please referring to FIG. 2A, the conductive liquid 140 in FIG. 1B on an expanding state is illustrated in FIG. 2A. When the first electric potential V111 corresponding to the first electrode 111 is significantly less than the second electric potential V112 corresponding to the second electrode 112, a larger first voltage difference (V112-V111) is generated on the contact surface 150a of the conductive liquid 140 and the insulation layer 150. The first electrode 111 applies more negative charges to the conductive liquid 140. As a result, more negative charges gather on the contact surface 150a. Also, more positive charges gather on the contact surface 150a. In FIG. 2A, the first voltage difference (V112-V111) is considerably large. Many negative charges and positive charges gather on the contact surface 150a. Therefore, the contact surface 150a is hydrophilic. The conductive liquid 140 expands and spreads out on the contact surface 150a. As a result, the surface curvature of the conductive liquid 140 is smaller.

In the above-described electro-wetting phenomenon, the first voltage difference between the first electrode 111 and the second electrode 112 causes the conductive liquid 140 to protrude or expand. As a result, the surface curvature of the conductive liquid 140 is changed.

The display method of the eye module 100 of the present embodiment includes following steps. First, a light source 160 is provided. Next, the first voltage difference is generated in the conductive liquid 140 to change the surface curvature of the conductive liquid 140. Light L160 is diverged or converged for changing the brightness of the pupil.

As shown in FIG. 1B and FIG. 2A, the eye element 101 further includes the light source 160 disposed on one side of the conductive liquid 111 and emitting the light L160 passing through the conductive liquid 140. The second electrode 112, the insulation layer 150, the conductive liquid 140 and the first electrode 111 are transparent. Therefore, the light L160 is able to pass through the second electrode 112, the insulation layer 150, the conductive liquid 140 and the first electrode 111 orderly and then emitted to the surroundings. In the present embodiment, the light source 160 is a light emitting diode (LED). When the conductive liquid 140 deforms, the surface curvature of the conductive liquid 140 changes to diverge or converge the light L160. As a result, the brightness of the pupil is changed.

Please refer to both FIG. 1B and FIG. 1C. FIG. 1C illustrates the eye module 100 in FIG. 1B applied to a robot pet 190. Two eye modules 100 are disposed inside a transparent casing 130 of the robot pet 190 for representing the left eye and right eye of the robot pet 190. As shown in FIG. 1 B, when the surface curvature of the conductive liquid 140 is larger, the focal point of the conductive liquid 140 is located on the light source 160. The light L160 emitted by the light source 160 passes through the conductive liquid 140 clearly and then emitted to the surroundings. Therefore, the pupil of the robot pet 190 is lighted, as shown in FIG. 1C.

Please refer to FIGS. 2A˜2B. FIG. 2B illustrates the eyes of the robot pet 190 in FIG. 1C on another state. As shown in FIG. 2A, when the surface curvature of the conductive liquid 140 is smaller, the focal point of the conductive liquid 140 is located below the light source 160. The light L160 emitted by the light source 160 is not able to pass through the conductive liquid 140 clearly and emitted to the surroundings. Therefore, the pupil of the robot pet 190 is lighted dimly, as shown in FIG. 2B.

### Second Embodiment

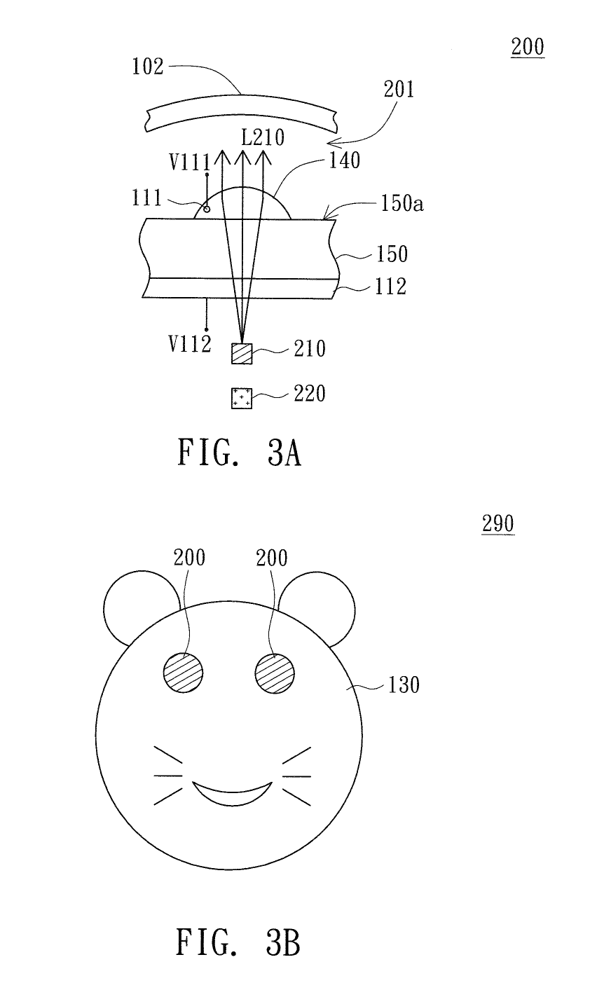

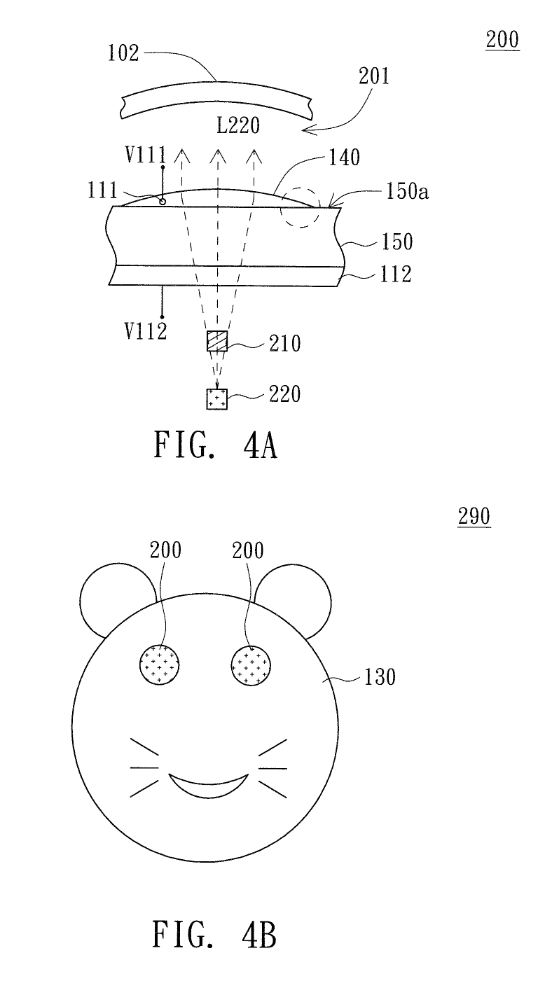

The eye module 200 of a second embodiment and the eye module 100 of the first embodiment are different for the light source design. Other parts are the same and not described repeatedly. Please referring to FIGS. 3A˜4B, the eye module 200 and the robot pet 290 according to the second embodiment are illustrated in FIGS. 3A˜4B. The eye element 201 of the eye module 200 includes a first light source 210 and a second light source 220. The first light source 210 is disposed on one side of the conductive liquid 140 and emits first color light L210. The second light source L220 is disposed on one side of the conductive liquid 140 and emits second color light L220. When the conductive liquid 140 deforms, the surface curvature of the conductive liquid 140 changes for converging or diverging the first color light L210 or the second color light L220. As a result, the color of the pupil is changed.

Please refer to FIGS. 3A˜3B. When the surface curvature of the conductive liquid 140 is larger, the focal point of the conductive liquid 140 is located o the first light source 210. The first color light L210 emitted by the first light source 210 is able to pass through the conductive liquid 140 clearly and then emitted to the surroundings. Therefore, the pupil of the robot pet 290 emits the first color light L210.

Please refer to FIGS. 4A˜4B. When the surface curvature of the conductive liquid 140 is smaller, the focal point of the conductive liquid 140 is located on the second light source 220. The light L220 emitted by the second light source 220 is able to pass through the conductive liquid 140 clearly and emitted to the surroundings. Therefore, the pupil of the robot pet 290 emits the second color light L220.

### Third Embodiment

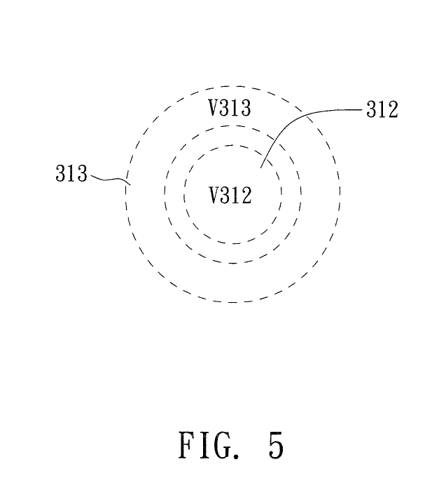

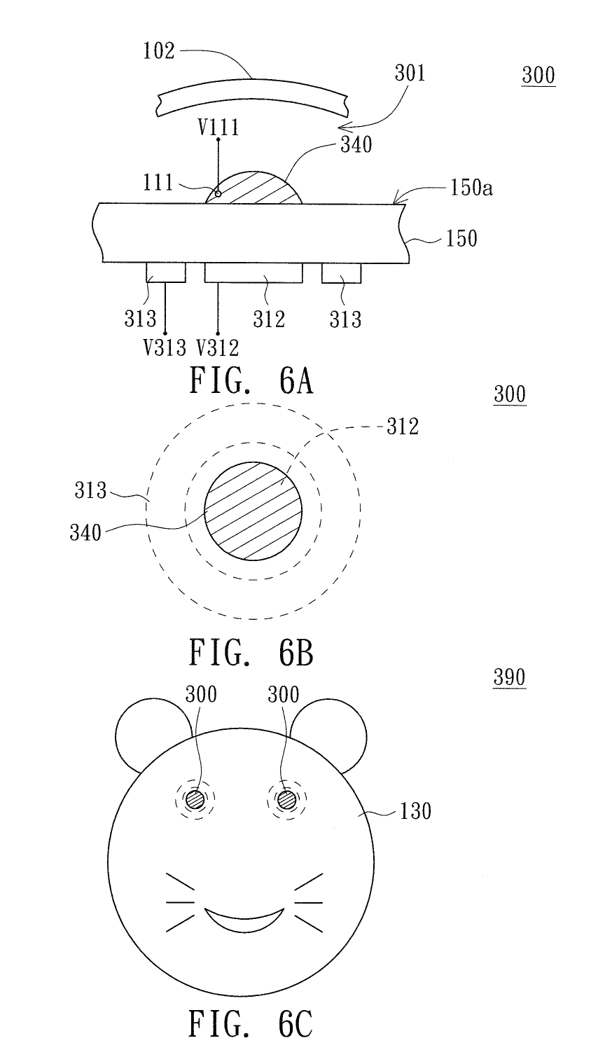

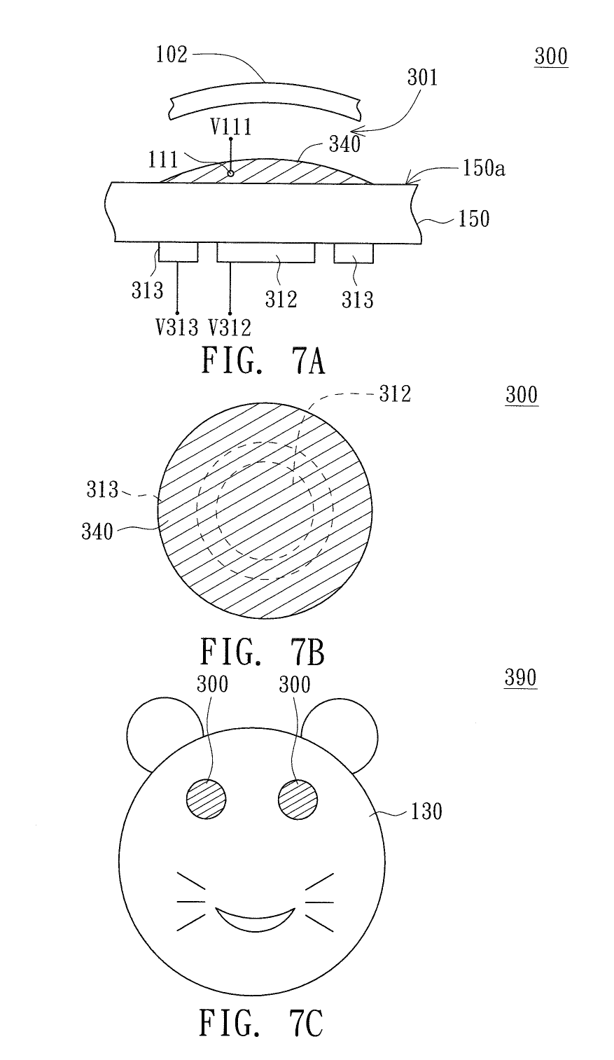

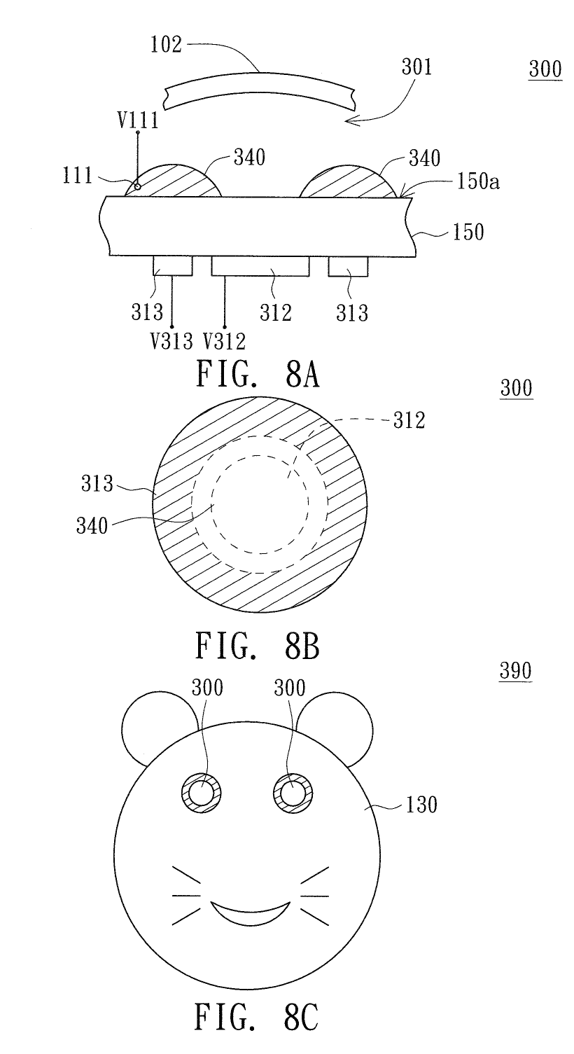

The eye module 300 of a third embodiment and the eye module 100 of the first embodiment are different for the electrodes layout design. Other parts are the same and not described redundantly. Please refer to FIG. 5 and FIGS. 6A˜8C. FIG. 5 illustrates the arrangement of the second electrode 312 and the third electrode 313 according to the third embodiment. FIGS. 6A˜8C illustrate the eye module 300 and the robot pet 390 according to the third embodiment. As shown in FIG. 5, the eye element 301 of the eye module 300 includes the second electrode 312 and the third electrode 313 (the eye module 300 and the eye element 301 shown in FIG. 6A). The second electrode 312 is located at a first position which is in the center of the eye module 300. The third electrode 313 is located at a second position which is on the periphery of the eye module 300.

As shown in FIG. 6A, the second electrode 312 and the third electrode 313 are electrically isolated from the first electrode 111 respectively. A first voltage difference is generated between the first electrode 111 and the second electrode 312. A second voltage difference is generated between the first electrode 111 and the third electrode 313. The first voltage difference and the second voltage difference are applied to the conductive liquid 340 respectively, so that the conductive liquid 340 deforms, expands or moves accordingly.

When the first electric potential V111 corresponding to the first electrode 111 is used as reference electric potential, the first voltage difference (V312-V111) changes relatively to the change of the second electric potential V312 corresponding to the second electrode 312. When the third electric potential V313 corresponding to the third electrode 313 changes, the second voltage difference (V313-V111) changes relatively.

Furthermore, in the present embodiment, the conductive liquid 340 is made of a colored material. Preferably, the conductive liquid 340 is dark or black for representing the pupil.

Please refer to FIGS. 6A˜6C. When the second electric potential V312 is slightly higher than the third electric potential V313 (or even the same), the conductive liquid 340 only expands to the first position (the center of the eye module 300). Therefore, the pupil of the robot pet 390 is located in the center of the eye module 300.

Please refer to FIGS. 7A˜7C. When the third electric potential V313 is high, the second voltage difference (V313-V111) is increased. More positive/negative charges are attracted onto the contact surface above the third electrode 313. The contact surface above the third electrode 313 becomes hydrophilic. As a result, the conductive liquid 140 expands outward to the second position (the periphery of the eye module 300). Therefore, the pupil of the robot pet dilates.

Please refer to FIGS. 8A˜8C. After the pupil of the robot pet 390 dilates, the first voltage difference (V312-V111) is reduced to the second voltage difference (V313-V111). More positive/negative charges are attracted onto the periphery of the contact surface than the center. Therefore, the conductive liquid 140 becomes more hydrophilic on the periphery of the contact surface than the center. The pupil of the robot pet 390 becomes circular.

### Fourth Embodiment

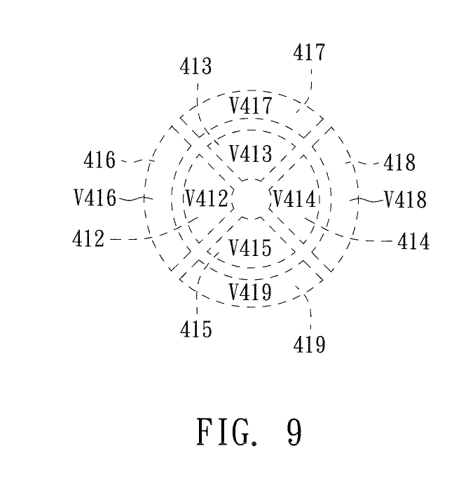

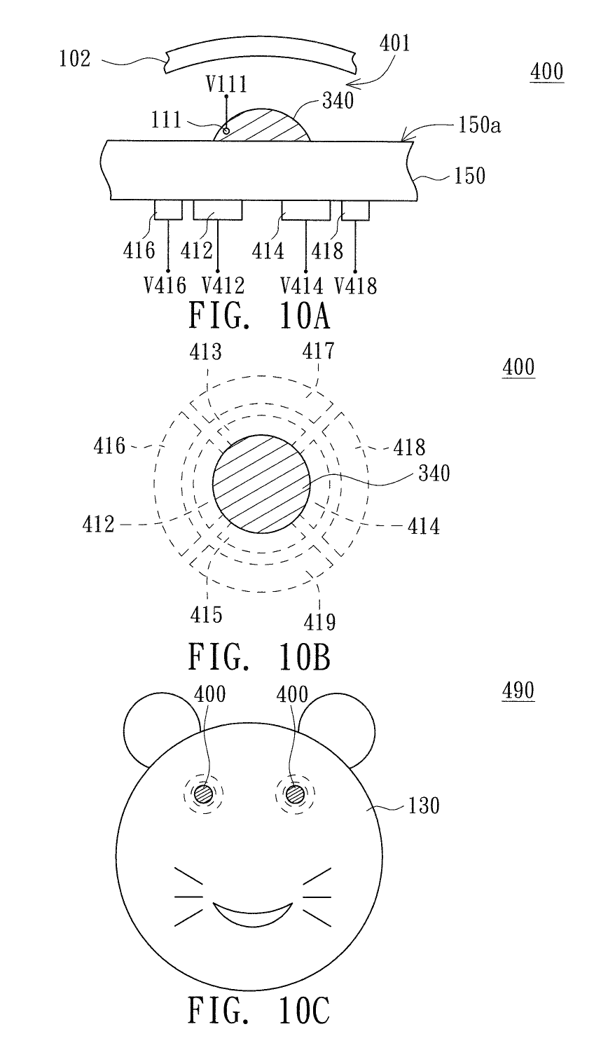

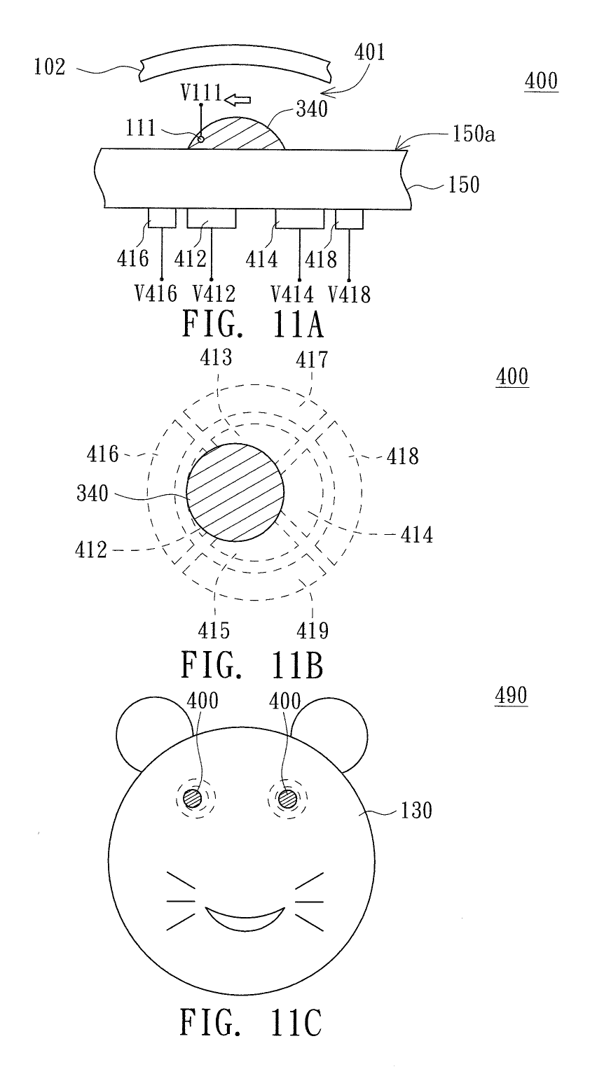

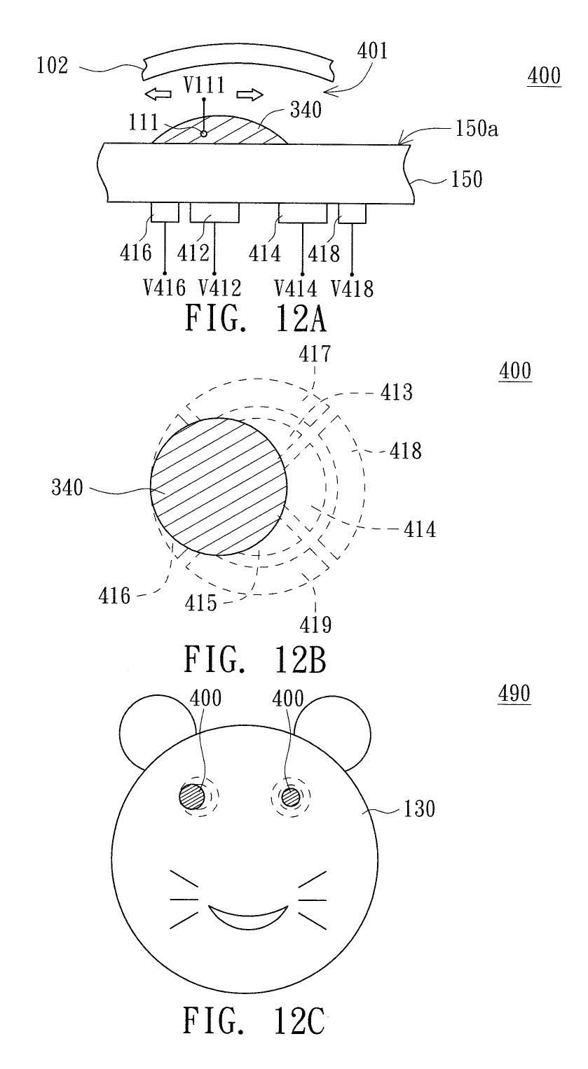

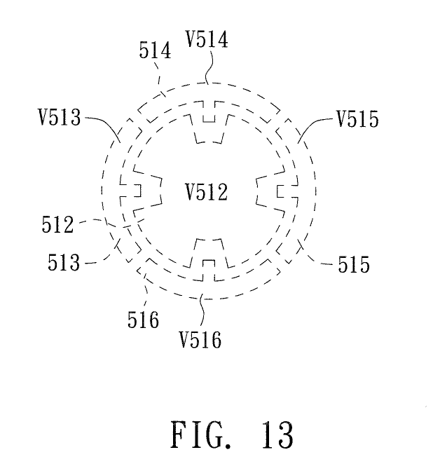

The eye module 400 of a fourth embodiment and the eye module 300 of the third embodiment are different for the electrodes layout design. Other parts are the same and not described redundantly. Please refer to FIG. 9 and FIGS. 10A˜12C. FIG. 9 illustrates the second electrode 412, the third electrode 413 . . . and the ninth electrode 419 according to the fourth embodiment. FIGS. 10A˜12C illustrate the eye module 400 and the robot pet 490 according to the fourth embodiment. As shown in FIG. 9, the eye element 401 of the eye module 400 includes the second electrode 412, the third electrode 413, the fourth electrode 414, the fifth electrode 415, the sixth electrode 416, the seventh electrode 417, the eighth electrode 418 and the ninth electrode 419 (the eye module 400 and the eye element 401 shown in FIG. 10A). The second electrode 412, the third electrode 413, the fourth electrode 414 and the fifth electrode 415 are circularly disposed in the center of the eye module 400 orderly. The sixth electrode 416, the seventh electrode 417, the eighth electrode 418 and the ninth electrode 419 are circularly disposed on the periphery of the eye module 400.

As shown in FIG. 1A, the second electrode 412, the third electrode 413 . . . and the ninth electrode 419 are electrically isolated from the first electrode 111 respectively. Voltage differences are generated between the first electrode 111 and each one of the second electrode 412 . . . and the ninth electrode 419. The voltage differences are applied to the conductive liquid 340 respectively to cause the deformation, expansion or displacement of the conductive liquid 340.

When the first electric potential V111 corresponding to the first electrode 111 is used as reference electric potential, the voltage differences changes relatively to the change of the second electric potential V412 . . . and the ninth electric potential V419 corresponding to the second electrode 412 . . . and the ninth electrode 419.

Please refer to FIGS. 10A˜10C. When the second electric potential V412 . . . and the ninth electric potential V419 are substantially the same, the conductive liquid 340 is pulled by the pulling forces generated by the second electrode 412 and the ninth electrode 419. When the pulling forces are balanced, the conductive liquid 340 is located in the center of the eye module 400. Therefore, the pupil of the robot pet 490 is located in the center of the eye module 400.

Please refer to FIGS. 11A˜11C. When the second electric potential V412 is increased to high value transiently, the conductive liquid 340 further expands to the place above the second electrode 412. Then, when the second electric potential V412 is reduced to low value, the pulling forces generated by the second electrode 412 and the ninth electrode 419 are balanced again. As a result, the conductive liquid 340 returns to the original size and stops expanding or moving. Therefore, the pupil of the left eye of the robot pet 490 moves leftward. In FIG. 11C, the pupil of the left eye moves leftward compared to the pupil of the right eye on the original state.

Please refer to FIGS. 12A˜12C. When the sixth electric potential V416 and the second electric potential V412 remain high, the conductive liquid 340 further expands to the place above the sixth electrode 416 and the second electrode 412. Because the conductive liquid 340 is affected by the high potential of the sixth electrode 416 and the second electrode 412, the contact surface above the sixth electrode 416 and the second electrode 412 is hydrophilic. The conductive liquid 340 moves leftward and spreads out. Therefore, the pupil of the left eye of the robot pet 490 moves leftward and dilates. In FIG. 12C, the pupil of the left eye moves leftward and dilates compared to the pupil of the right eye on the original state.

### Fifth Embodiment

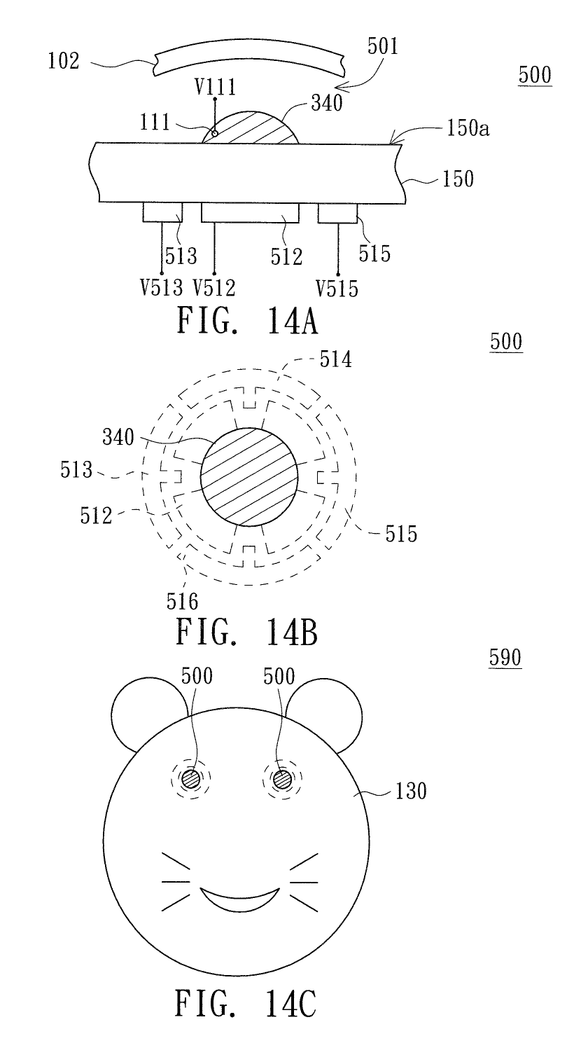

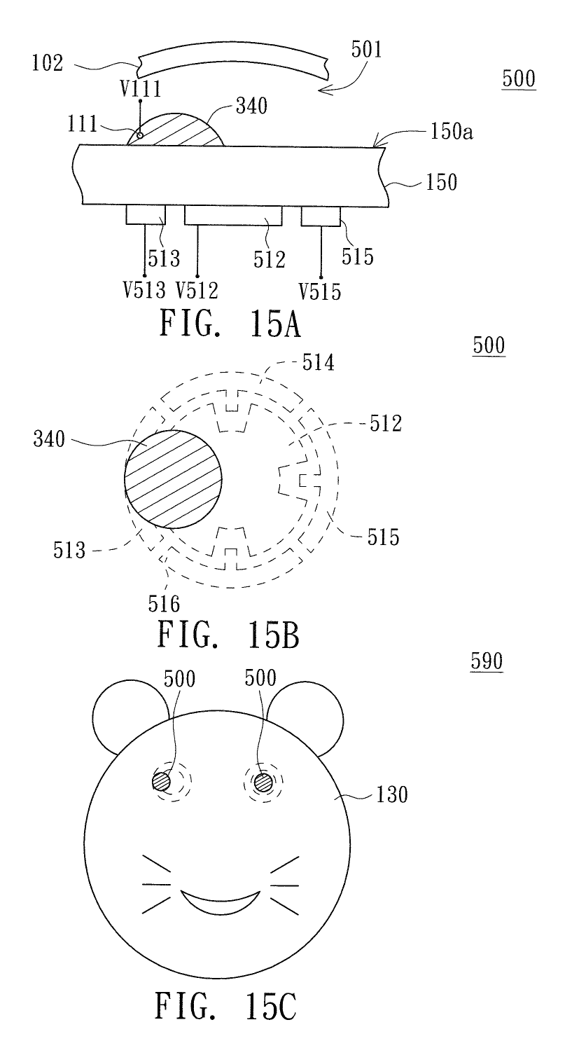

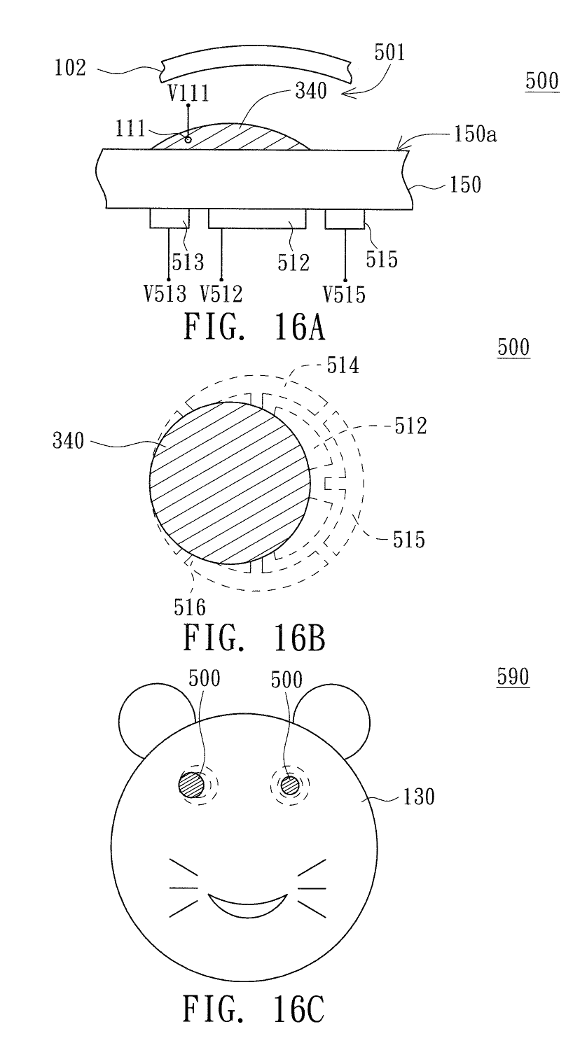

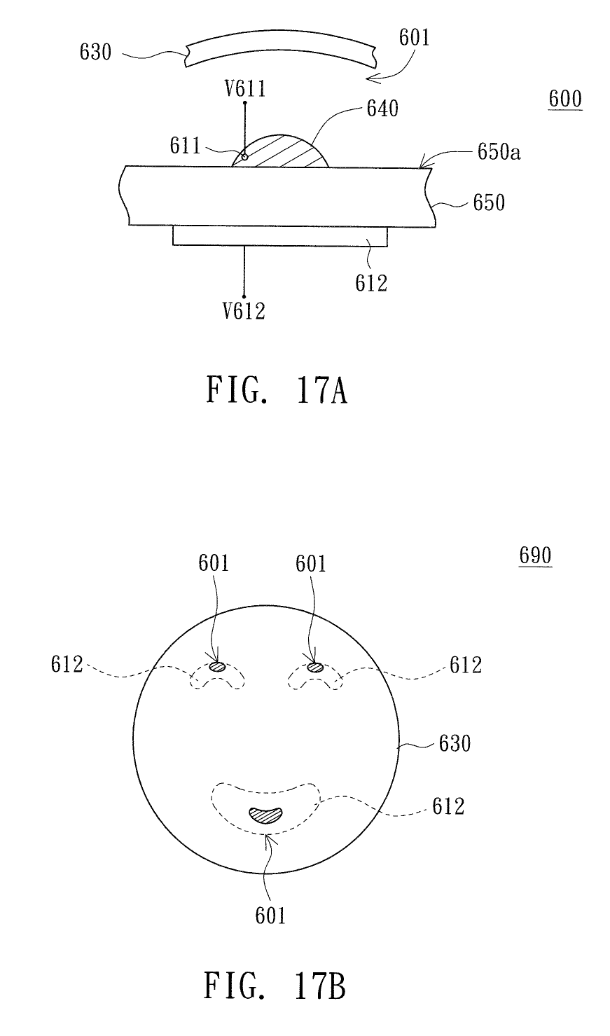

The eye module 500 of a fifth embodiment and the eye module 400 of the fourth embodiment are different for the electrodes layout design. Other parts are the same and not described repeatedly. Please refer to FIG. 13 and FIGS. 14A˜16C. FIG. 13 illustrates the second electrode 512 . . . and the sixth electrode 516 according to the fifth embodiment. FIGS. 14A˜16C illustrate the eye module 500 and the robot pet 590 according to the fifth embodiment. As shown in FIG. 13, the eye element 501 of the eye module 500 includes the second electrode 512, the third electrode 513, the fourth electrode 514, the fifth electrode 515 and the sixth electrode 516. The second electrode 512 is disposed in the center of the eye module 500. The third electrode 513 . . . and the sixth electrode 516 are circularly disposed on the periphery of the eye module 500 (the eye module 500 and the eye element 501 are shown in FIG. 14A).

The third electrode 513 . . . and the sixth electrode 516 extend toward the indent of the second electrode 512. As a result, the third electrode 513 . . . and the sixth electrode 516 cause the deformation, expansion or displacement of the conductive liquid 340 more easily.

Please refer to FIGS. 14A˜14C. When the second electric potential V512 . . . and the sixth electric potential V516 are substantially the same, the conductive liquid 340 is located in the center of the eye module 500. Therefore, the pupil of the robot pet 590 is located in the center of the eye module 500.

Please refer to FIGS. 15A˜15C. When the third electric potential V513 increases to a high value transiently, the conductive liquid 340 further expands to the place above the third electrode 513. After, when the third electric potential V513 returns to the low value, the conductive liquid 340 returns to the original size and stops expanding or moving. Therefore, the pupil of the left eye of the robot pet 590 moves leftward. In FIG. 15C, the pupil of the left eye moves leftward compared to the pupil of the right eye on the original state.

Please refer to FIGS. 16A˜16C. When the second electric potential V512 and the third electric potential V513 remain in high values, the conductive liquid 340 moves leftward and spreads out. Therefore, the pupil of the left eye of the robot pet 590 moves leftward and dilates. In FIG. 16C, the pupil of the left eye moves leftward and dilates compared to the pupil of the right eye on the original state.

### Sixth Embodiment

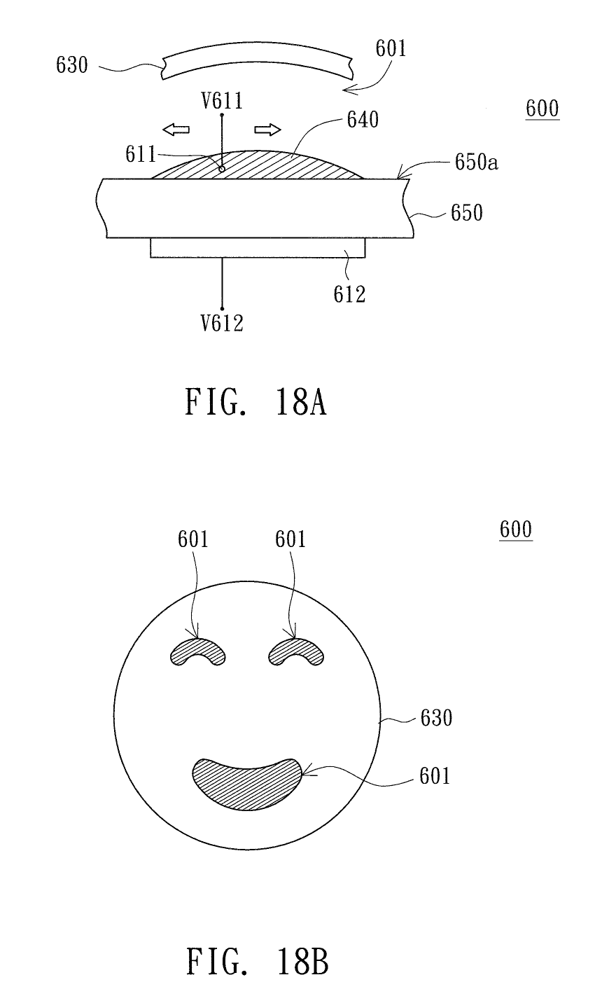

Please referring to FIGS. 17A˜18B, a facial expression module 600 according to a sixth embodiment of the present invention is illustrated in FIGS. 17A˜18B. The facial expression module 600 at least includes a transparent casing 630 and an expression element 601. The expression element 601 is disposed inside the transparent casing 630 for representing an expression. The expression element 601 includes conductive liquid 640, a first electrode 611 and a second electrode 612. The conductive liquid 640 is for representing an expression. The first electrode 611 is coupled with the conductive liquid 640. The second electrode 612 is electrically isolated from the first electrode 611 and the conductive liquid 640 through an insulation layer 650. The first electrode 611 and the second electrode 612 generate first voltage difference in the conductive liquid 640 for causing the conductive the deformation, expansion or displacement of the conductive liquid 640. As a result, the expression is changed. The expression element 601 is disposed inside the transparent casing 630, which is a face of a robot. The expression element 601 is for representing the facial expression of the robot.

As shown in FIG. 17A, the first electrode 611 directly contacts the conductive liquid 640. The facial expression module 600 further includes an insulation layer 650 disposed between the second electrode 612 and the conductive liquid 640.

Please refer to FIGS. 17A˜17B. When the second electric potential V612 is slightly higher than the first electric potential V611, the place between the conductive liquid 640 and contact surface 650a is hydrophobic. As a result, the conductive liquid 640 only expands to the contact surface 650a corresponding to the center of the second electrode 612. Therefore, the robot has small eyes and small mouth.

Please refer to FIGS. 18A˜18B. When the second electric potential V612 is high, the place between the conductive liquid 640 and the contact surface 650a is hydrophilic. As a result, the conductive liquid 640 further extends outward to the contact surface 650a above the second electrode 612. Therefore, the robot has smiling eyes and a smiling mouth.

Although one second electrode 612 is illustrated in the facial expression module 600 of the present embodiment as an example, the facial expression module 600 can include several electrodes to express various expressions vividly.

### Seventh Embodiment

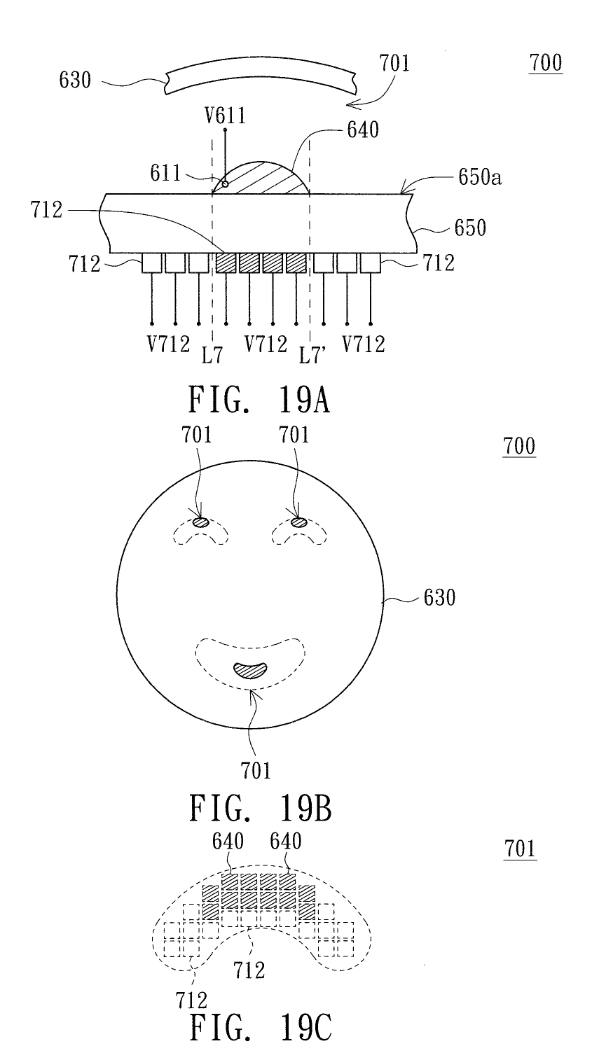

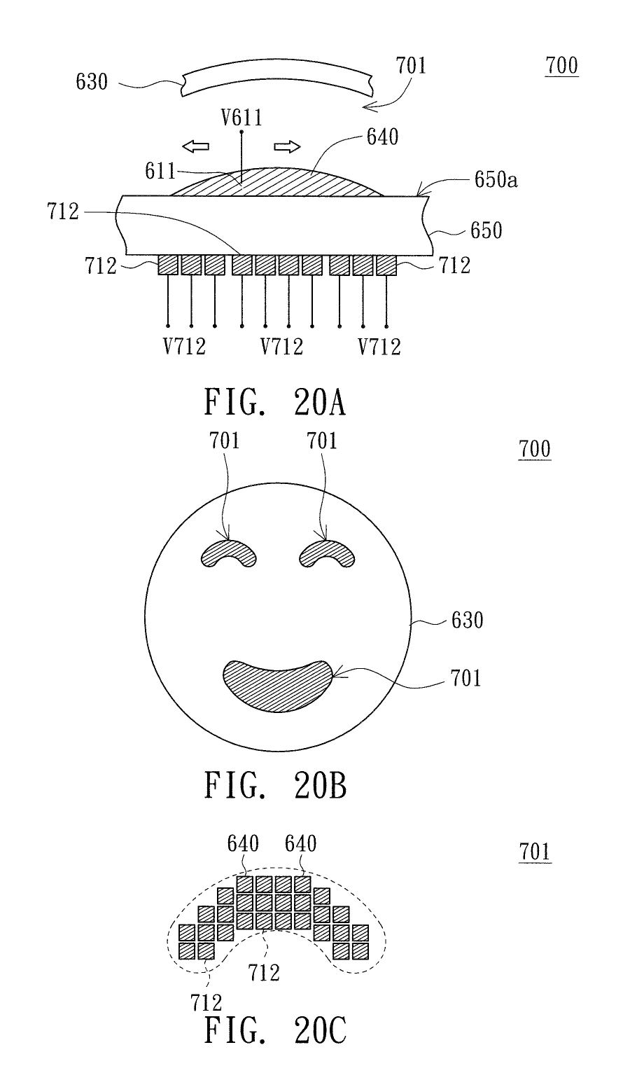

The facial expression module 700 of a seventh embodiment and the facial expression module 600 of the sixth embodiment are different for the electrodes layout design. Other parts are the same and not described repeatedly. Please refer to FIGS. 19A˜20B. FIGS. 19A˜20C illustrate the facial expression module 700 according to the seventh embodiment of the present invention. The facial expression module 700 includes several second electrodes 712 arranged in an array. The second electrodes 712 are electrically isolated from the first electrode 611 and the conductive liquid 640 respectively. The second electric potentials V712 corresponding to the second electrodes 712 are the same or different.

Please refer to FIGS. 19A˜19C. When the second electric potential V712 between the dotted lines 7 and 7′ is high, the conductive liquid 640 expands to the place above the second electrode 712 between the dotted lines 7 and 7′. As a result, the conductive liquid 640 expands to the contact surface 650a above the second electrode 712 between the dotted lines 7 and 7′. Therefore, the robot has small eyes and a small mouth.

Please refer to FIGS. 20A˜20C. When all the second electric potential V712 are high, the conductive liquid 640 spreads out more flatly. Therefore, the robot has big eyes and a big mouth.

Although all the second electric potentials V712 between the dotted line 7 and 7′ are controlled in the facial expression module 700 of the present embodiment as an example, the facial expression module 700 can control each second electric potential individually to have various expressions.

Although each electrode is located in a certain place in the above embodiments, the electrodes can be disposed differently according to the demand. As long as the voltage difference is generated in the conductive liquid to cause the deformation, expansion or displacement of the conductive liquid for changing the pupil or the facial expression, such modifications are encompassed by the present invention.

In the eye module and the facial expression module and the display method thereof according to the above embodiments, the voltage difference is generated in the conductive liquid to cause the deformation, expansion or displacement of the conductive liquid. As a result, the pupil or facial expression is changed. The eye module and the facial expression module and the display method thereof have following advantages.

First, the structure is simple. The eye module and the facial expression module only include the conductive liquid, the first electrode and at least one second electrode to represent different pupil and the facial expression. The structure is simple and easily designed.

Second, the noise is low. There is no need to use any motor or gear. Power is input to generate the voltage difference to drive the deformation, expansion or displacement of the conductive liquid. Therefore, there is almost no noise during the driving process of the eye module and the facial expression module.

Third, even when used for a long time or many times, the conductive liquid is not worn out. Therefore, the eye module and the facial expression module of the present invention have long service life.

Fourth, the size is compact. The volume of each element of the present invention can be reduced according to the demand. Therefore, the eye module and the facial expression module are light-weight, thin and compact.

Firth, the facial expression is vivid. The pupil and the facial expression are different according to the design of the electrodes. The conductive liquid changes according to the electric potential of each electrode. Therefore, the pupil and the facial expression are more vivid.

Sixth, the change has several stages. Through the arrangement of each electrode and control of each corresponding electric potential, the pupil and the facial expression have changes in several stages.

Seventh, the eye module and the facial expression module of the present invention have low cost and simple structure, which are suitable for mass production.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An eye module at least comprising:
a transparent casing; and
an eye element disposed inside the transparent casing for representing a pupil of the eye module, the eye element comprising:
a conductive liquid for representing the pupil;
a first electrode coupled with the conductive liquid; and
a second electrode electrically isolated from the first electrode and the conductive liquid;
wherein the first electrode and the second electrode generate a first voltage difference in the conductive liquid to cause the deformation, expansion or displacement of the conductive liquid for changing the pupil

2. The eye module according to claim 1, wherein the eye element further comprises:
an insulation layer disposed between the second electrode and the conductive liquid.

3. The eye module according to claim 1, wherein the eye element further comprises:
a light source disposed on a side of the conductive liquid and emitting light passing through the conductive liquid;
wherein the surface curvature of the conductive liquid is changed to diverge or converge the light for changing the brightness of the pupil when the conductive liquid deforms.

4. The eye module according to claim 1, wherein the eye element further comprises:
a first light source disposed on a side of the conductive liquid and emitting first color light; and
a second light source disposed on a side of the conductive liquid and emitting second color light;
wherein the surface curvature of the conductive liquid is changed to converge the first color light or the second color light for changing the color of the pupil when the conductive liquid deforms.

5. The eye module according to claim 1, wherein the eye element further comprises:
a third electrode electrically isolated from the first electrode, the first electrode and the third electrode generating a second voltage difference in the conductive liquid to cause the deformation, expansion or displacement of the conductive liquid.

6. The eye module according to claim 1, wherein the second electrode is disposed at a first position of the eye element for controlling the conductive liquid to expand to the first position, the third electrode disposed at a second position of the eye element for controlling the conductive liquid to expand to the second position.

7. The eye module according to claim 6, wherein the first position is the center of the eye element, and the second position is the periphery of the eye element;
wherein the pupil contracts when the conductive liquid expands to the first position;
wherein the pupil dilates when the conductive liquid expands to the second position.

8. The eye module according to claim 6, wherein the first position is the center of the eye element, and the second position is one side of the eye element;
wherein the pupil is located in the center when the conductive liquid expands to the first position;
wherein the pupil moves to the side when the conductive liquid expands to the second position.

9. The eye module according to claim 1, wherein the first electrode and the second electrode are made of metal or indium tin oxide (ITO).

10. The eye module according to claim 1, wherein the conductive liquid is made of a transparent material.

11. The eye module according to claim 1, wherein the conductive liquid is made of a colored material.

12. A facial expression module at least comprising:
a transparent casing; and
a facial expression element disposed inside the transparent casing for representing an expression, the facial expression element comprising:
a conductive liquid for representing the expression;
a first electrode coupled with the conductive liquid; and
a second electrode electrically isolated from the first electrode and the conductive liquid;
wherein the first electrode and the second electrode generate a first voltage difference in the conductive liquid to cause the deformation, expansion or displacement of the conductive liquid for changing the expression.

13. The facial expression module according to claim 12 further comprising:
an insulation layer disposed between the second electrode and the conductive liquid.

14. The facial expression module according to claim 12, wherein the expression element is disposed on a face of a robot for representing a facial expression of the robot.

15. The facial expression module according to claim 12, wherein the expression element further comprises:
a third electrode electrically isolated from the first electrode, the first electrode and the third electrode generating a second voltage difference in the conductive liquid to cause the deformation, expansion or displacement of the conductive liquid.

16. The facial expression module according to claim 12, wherein the first electrode and the second electrode are made of metal or indium tin oxide (ITO).

17. The facial expression module according to claim 12, wherein the expression element comprises a plurality of second electrodes, each second electrode electrically isolated from the conductive liquid;
wherein the first electrode and the second electrodes generate a plurality of voltage differences in the conductive liquid to cause the deformation, expansion or displacement of the conductive liquid for changing the expression.

18. A display method of an eye module, the eye module comprising a transparent casing and an eye element disposed inside the transparent casing, the eye element comprising a conductive liquid for representing a pupil of the eye module, the method comprising:
forming a voltage difference in the conductive liquid to cause the deformation, expansion or displacement of the conductive liquid for changing the pupil.

19. The method according to claim 18 further comprising:
providing a light source and emitting light passing through the conductive liquid; and
forming the voltage difference in the conductive liquid to change the surface curvature of the conductive liquid for diverging or converging the light and changing the brightness of the pupil accordingly.

20. The method according to claim 18 further comprising:
providing a first light source disposed on one side of the conductive liquid and emitting first color light;
providing a second light source disposed on one side of the conductive liquid and emitting second color light; and
forming the voltage difference in the conductive liquid to change the surface curvature of the conductive liquid, for converging the first color light or the second color light and changing the color of the pupil accordingly.

21. A display method of the facial expression module, wherein the facial expression module comprising a transparent casing and an expression element disposed inside the transparent casing, the expression element comprising a conductive liquid for representing an expression, the method comprising:
forming a voltage difference in the conductive liquid to cause the deformation, expansion or displacement of the conductive liquid for changing the expression.
